(19) United States
(12) Patent Application Publication
(10) Pub. No.: US 2013/0144844 A1
(43) Pub. Date: Jun. 6, 2013

(54) COMPUTER SYSTEM AND FILE SYSTEM MANAGEMENT METHOD USING THE SAME

(71) Applicants: Akira Ito, Yokohama (JP); Jun Nemoto, Tokyo (JP); Atsushi Sutoh, Yokohama (JP)

(72) Inventors: Akira Ito, Yokohama (JP); Jun Nemoto, Tokyo (JP); Atsushi Sutoh, Yokohama (JP)

(73) Assignee: HITACHI, LTD., Tokyo (JP)

(21) Appl. No.: 13/377,702

(22) PCT Filed: Dec. 1, 2011
(86) PCT No.: PCT/JP2011/006744

§ 371 Date: Dec. 12, 2011

(51) Int. Cl. G06F 17/30

(52) U.S. Cl. 707/688; 707/E17.01; 707/E17.005

(57) ABSTRACT

The present invention provides a computer system capable of providing the latest statistics on a file system in real time. The computer system includes a memory having a program for executing statistics on a file system, and a controller for executing the program. When the file system is accessed, the controller compares first statistic information before access processing on the file system with second statistic information after the access processing; and if it is determined that any difference exists between the first statistic information and the second statistic information, the controller updates the statistic result of the file system based on the difference.

### TECHNICAL FIELD

The present invention relates to a computer system. Particularly, the invention relates to a computer system and file system management method suited for use in acquisition of statistic information of file systems.

### BACKGROUND ART

Recently, the difficulty of storage capacity management and stored file management has been increasing due to diversification of files/content stored in storage systems. If a storage administrator becomes aware of a tendency of stored files according to, for example, types and size of files to be stored, and update dates and times, and a file increase/decrease tendency the storage administrator can efficiently manage storage capacity plans and file migration. So, an efficient method for obtaining the tendency of files stored in file systems, that is, statistic information, is required.

Main types of the statistic information to find the tendency of files stored in the file storage system are as follows. A first type is size distribution of each of pluralities of files and their chronological variation. A second type is distribution of extensions of each file and their chronological variation. A third type is distribution of update dates and times and access dates and times of each file and their chronological variation. A fourth type is a combination of these types, for example, how access dates and times of files with a certain extension are distributed. The statistic information of files is stored in, for example, a database or a table and users can refer to the statistic information via a GUI.

An administrative user of a storage system needs to refer to metadata of files and collect them in order to obtain the statistic information. Regarding the conventional technology, there is a method, which is implemented by a statistic information collection program, for collecting metadata of the entire file system as a target, storing the collected information in, for example, a database or a table, and calculating the statistic information. If this method is employed, the statistic information collection program needs to periodically refer to the metadata of all files existing in the file system and it takes a lot of time to collect the metadata, which is not efficient.

Therefore, there is a method executed by a metadata collection system for reporting a change of metadata to a system of a storage user when the metadata is changed, as a method for efficiently collecting the metadata (U.S. Pat. No. 7,890,551). According to this method, the latest metadata is efficiently collected by reporting an event of the metadata change to the user.

Another conventional technique is a system for efficiently collecting any change of metadata from snapshots of the metadata (U.S. Pat. No. 7,693,864). According to this system, snapshots of a file system are periodically obtained and any difference between metadata before the change and metadata after the change can be obtained by comparing the metadata in the past in the snapshots with the present metadata.

### CITATION LIST

### Patent Literature

PTL 1: U.S. Pat. No. 7,890,551

PTL 2: U.S. Pat. No. 7,693,864

### SUMMARY OF INVENTION

### Technical Problem

With the first conventional technique, changes of the metadata can be recognized, but how the metadata has changed cannot be recognized. So, it cannot determine how the changes of the metadata would influence the statistic information table. Therefore, every time the metadata changes, the system needs to refer to the metadata of the entire file system in order to update the statistic information table.

Then, with the second conventional technique, the metadata can be obtained only when obtaining snapshots. So, it is difficult to collect the statistic information of the file system in real time.

Therefore, it is an object of the present invention to provide a computer system capable of providing the latest statistics of a file system in real time. Another object of the present invention is to provide a computer system and file system management method capable of updating the statistics of the file system in real time without periodically collecting the statistic information of all files in the file system.

### Solution To Problem

So, the present invention is characterized in that when the file system is accessed, first statistic information before access processing on the file system is compared with second statistic information after the access processing; and if any difference exists between the first statistic information and the second statistic information, statistic results of the file system are updated based on the difference.

### Advantageous Effects of Invention

According to the present invention, a computer system capable of providing the latest statistics of the file system in real time can be provided. Particularly, it is possible to provide a computer system capable of updating the statistics of the file system in real time without periodically collecting the statistic information of all files in the file system.

### BRIEF DESCRIPTION OF DRAWINGS

FIG. 1 shows a block configuration diagram of a computer system according to an embodiment of the present invention.

FIG. 2 is a block diagram showing the detailed configuration of a file storage system.

FIG. 3 is an example of a policy table that is set by statistic information collection policy setting processing.

FIG. 4 shows an example of a statistic information table in which the statistic information is of a type classified by file extensions.

FIG. 5 shows an example of a statistic information table in which the statistic information is of a type classified by last access time to files.

FIG. 6 shows an example of a statistic information table in which the statistic information is of a type classified by file sizes.

FIG. 7 is a block diagram showing a data structure of metadata.

FIG. 8 is an example of a metadata collection table.

FIG. 9 is a policy setting GUI displayed on a screen of an input/output unit shown in FIG. 1.

FIG. 10 is a display example of statistic results of a file system.

FIG. 11A is a flowchart for explaining statistic information collection processing.

FIG. 11B is a flowchart for explaining statistic information collection processing which follows the processing in FIG. 11A.

FIG. 12A is a flowchart for explaining metadata collection processing.

FIG. 12B is a flowchart for explaining metadata collection processing which follows the processing in FIG. 12A.

FIG. 12C is a flowchart for explaining metadata collection processing which follows the processing in FIG. 12B.

### DESCRIPTION OF EMBODIMENTS

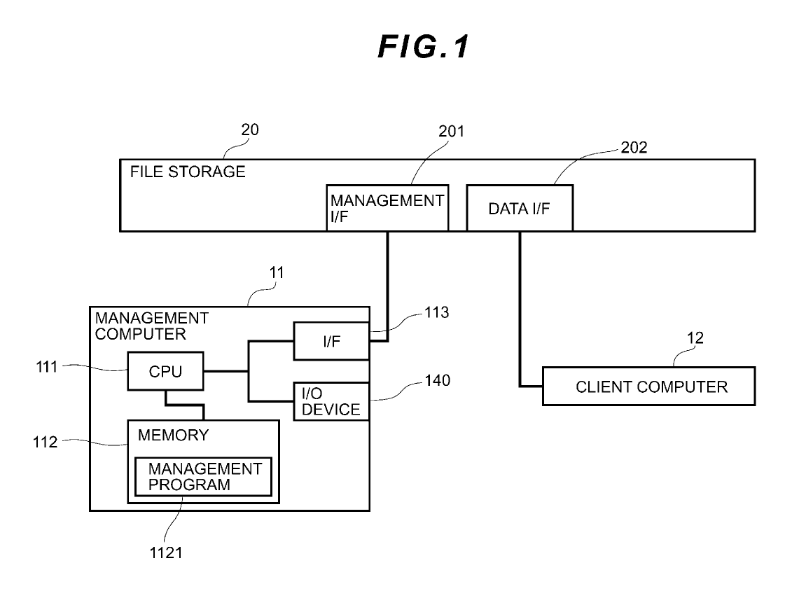

Next, an embodiment of the present invention will be explained. FIG. 1 shows a block configuration diagram of a computer system according to an embodiment of the present invention. The computer system includes, as main components, a file storage system 20 and a management computer 11 for the file storage system 20. One or more client computers 12 are connected to the file storage system.

The file storage system 20 includes a management interface 201 and a data interface 202. An interface 113 of the management computer 11 is connected to the management interface 201. The client computer 12 is connected to the data interface 202. The management computer 11 includes an arithmetic unit (CPU) 111, a memory 112 having a management program 1121 of the file storage system 20, and an I/O device 140 such as a screen for an administrative user.

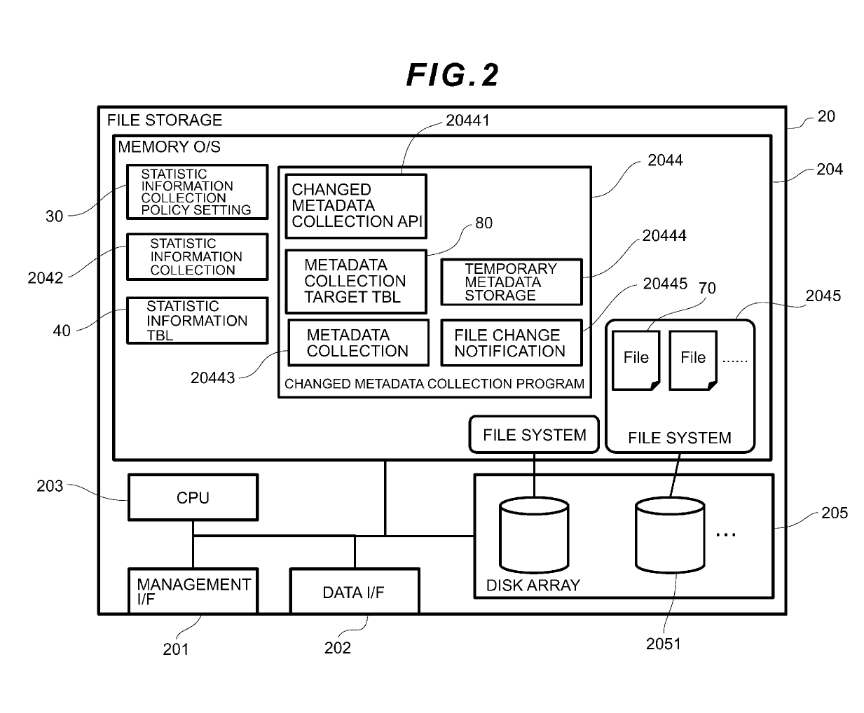

FIG. 2 is a block diagram showing the detailed configuration of the file storage system 20. The file storage system includes a memory 204, an arithmetic unit 203, and a disk array system 205 in which a plurality of hard disk drives 2051 are arranged in an array. The memory 204 stores an OS of the file storage system, an application program, and file systems 2045 for files 70 stored in the disk array system.

The application program is constructed as a changed metadata collection program 2044 for collecting changed metadata. The metadata is management information of files constituting a file system. The computer system uses the management information of the files as statistic information of the file system. Incidentally, the changed metadata collection program 2044 may be constructed as part of functions of the OS 204 or the file system 2045.

The changed metadata collection program 2044 has a function 20441 as an application program interface (API), a function 20443 collecting metadata, a function 20444 temporarily storing the metadata, and a function 20445 reporting updates to the file(s). Incidentally, for the sake of convenience, the function as a changed metadata collection application program interface (API) will be described as a changed metadata API (20441), the function collecting the metadata will be described as a metadata collection unit 20443, the function temporarily storing the metadata will be described as a temporary metadata storage unit 20444, and the function reporting updates to the files will be described as a file change notification unit 20445.

The memory 204 has a metadata collection target table 80 for specifying the types of metadata, which are targets to be collected, and file systems which are metadata collection targets, as an information management table that is necessary for the changed metadata collection program 2044 to fulfill the above-described functions.

The memory 204 has a statistic information processing program as an application program of a different tier from that of the changed metadata collection program 2044 or as a function of the OS. The statistic information processing program executes various processing for, for example, generating and updating statistics of the file systems. For example, the statistic information processing program has a function setting a policy for collecting the statistic information of the file systems (a statistic information collection policy setting unit 30), a function collecting the statistic information (a statistic information collection unit 2042), a function collecting the statistic information and executing processing on the collected statistic information (the statistic information collection processing unit 2042), and a statistic information table 40.

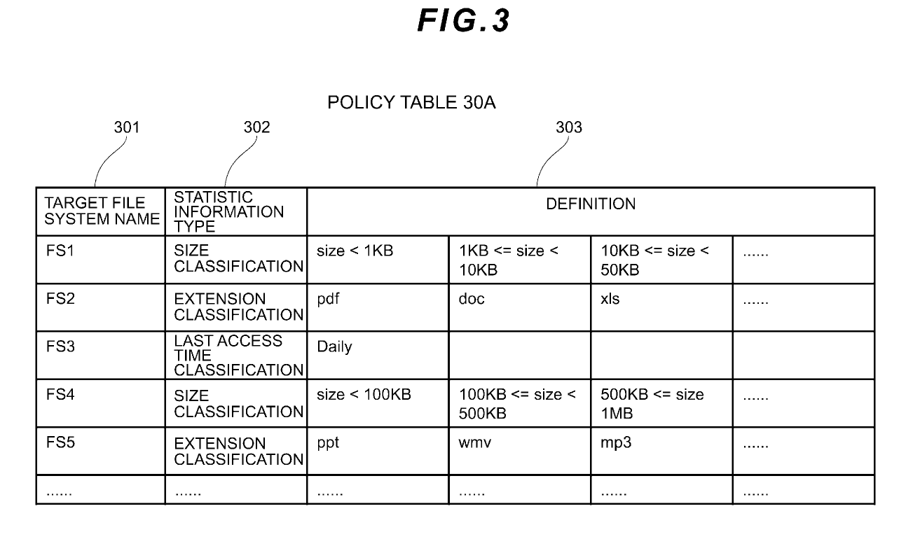

FIG. 3 is an example of a policy table 30A that is set by the statistic information collection policy setting unit 30. The policy table 30A is constituted from a file system name setting area 301 for specifying a file system (FS) which is a target to collect the statistic information from among file systems belonging to a storage area of the disk array system 205, a statistic information type setting area 302, and a definition information setting area 303.

FIG. 3 shows that examples of the types of the statistic information include file size classification, extension classification, and last access time classification. These pieces of information are provided from the metadata of files.

Furthermore, FIG. 3 shows that in the case of the file size classification, the file sizes are classified into less than 1 KB, 1 KB or more and less than 10 KB, and 10 KB or more; and in the case of the file extension classification, extensions are classified into Pdf, doc, and xls. FIG. 3 also shows that in the case of the last access time classification, accesses to the files are managed daily.

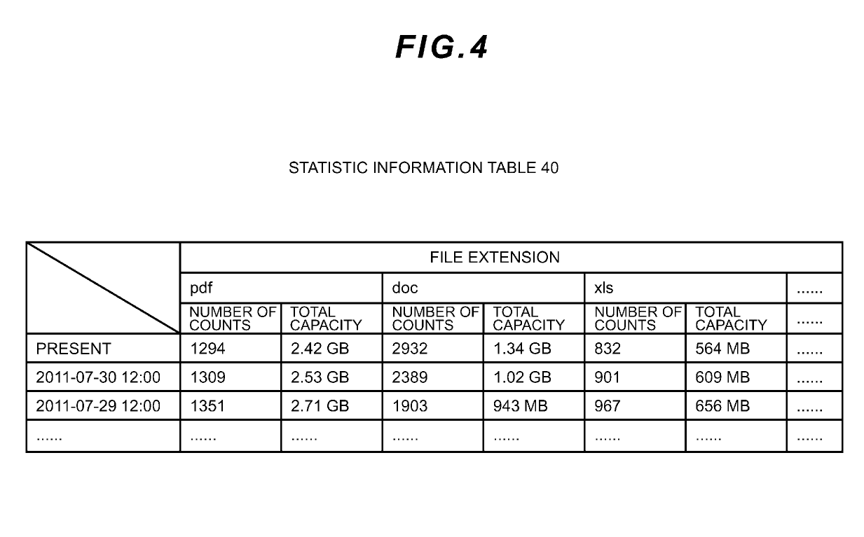

FIG. 4 shows an example of the statistic information table 40 for which the statistic information type is the file extension classification. The statistic information table 40, including those hereinafter explained, is set for each file system which is a target to obtain the statistic information. The statistic information table 40 may integrate a plurality of file systems. An area for setting the present statistic results and an area for the statistic results in the past points in time (for example, 2011-07-30 12:00 and 2011-07-29 12:00) are set to the statistic information table 40. The number of file counts of files with each extension and a total file size (total capacity) of files with the same extension are recorded at each management timing.

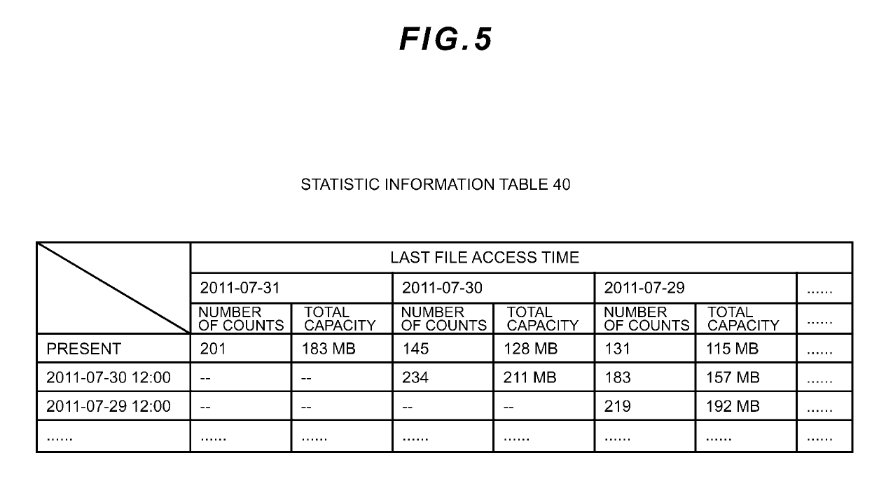

FIG. 5 shows an example of the statistic information table 40 for which the statistic information type is classification by the last access time to files. Present and past statistic areas are set to the statistic information table 40 in the same manner as in FIG. 4. Then, the last file access time is managed for each of the present point in time (2011-07-31 at present) and the past points in time (for example, 2011-07-30 12:00 and 2011-07-29 12:00) at each management timing. This management is executed based on the number of counts of a plurality of files belonging to the classified last file access time, and the total capacity of the plurality of files. Assuming that the present date is Jul. 31, 2011, the number of counts [201] on [2011-07-31] which belongs to the [present] area is an accumulated value of files accessed by a user computer(s) after 2011-07-31 00:00 until the present time. The number of counts [145] on [2011-07-30] is an accumulated value of files accessed by the user computer(s) after 2011-07-30 00:00 until 2011-07-31 00:00. Incidentally, if a file accessed at present was also accessed one day before, one is subtracted from the number of counts [145] on [2011-07-30] and one is added to the number of counts [201] on [2011-07-31]. Values in vertical columns for [2011-07-30 12:00] and [2011-07-31 12:00] in the table are the number of counts and the total capacity for the last file access time at each point in time in the statistic information table 40.

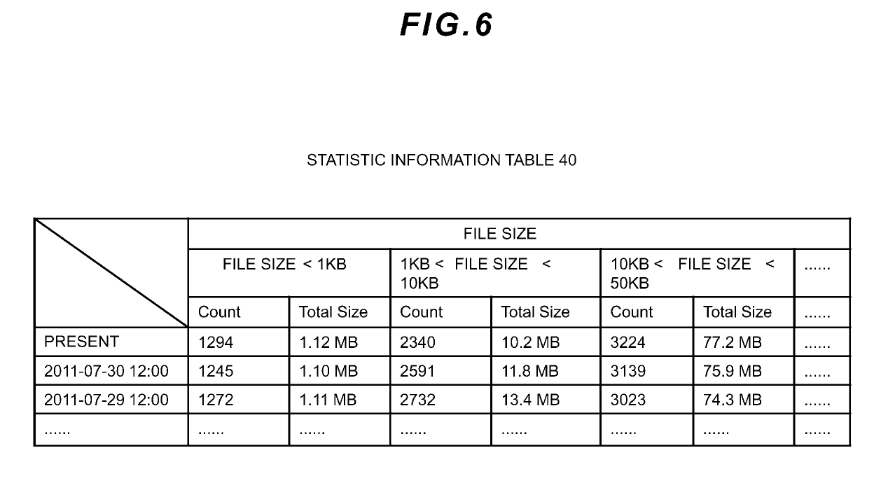

FIG. 6 shows an example of the statistic information table 40 for which the statistic information type is the file size classification. An area for setting the statistic information at present and an area for the statistic information at the past points in time (for example, 2011-07-30 12:00 and 2011-07-29 12:00) are set to the statistic information table 40. Then, a plurality of file size classification types of files belonging to the relevant file system which is the target to collect the statistic information are recorded in each area. The number of files and the total capacity are recorded for each file size classification type.

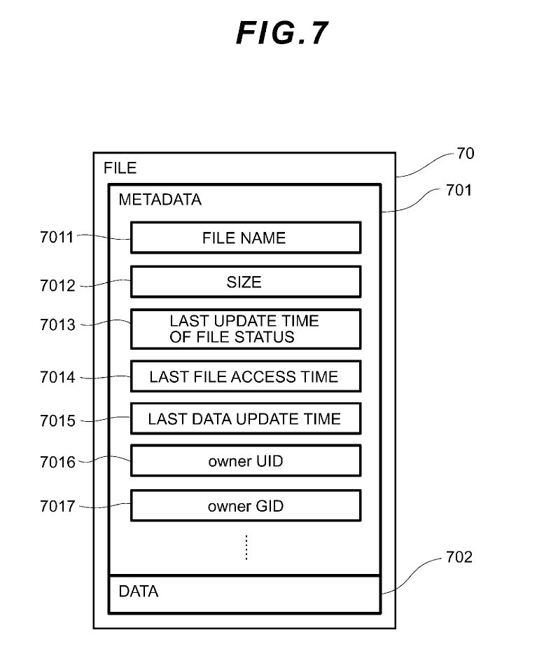

FIG. 7 is a block diagram showing a data structure of metadata. The file storage system 20 uses the metadata, which are attributes of files, as necessary file statistic information (management information) to obtain the statistics of the file system. A file 70 has a metadata 701 area and a data body area 702. The metadata includes a file name (extension) 7011, file capacity 7012, last file status update time 7013, last file access time 7014, last data update time 7015 (these three types of times corresponding to ctime, atime, and mtime, respectively, in Unix OS), a user ID 7016 of a file owner, and a group ID 7017 of the file owner. Incidentally, the statistic information of the file is not limited to the above-mentioned metadata, and information such as security information which is set to the relevant file (such as an encryption form, an encryption level, access limitations, and a RAID level), information about the use of the file (profile of a file user), and hierarchical information of the file may be included as metadata and any and all pieces of information about the attributes of a file can be used as the statistic information.

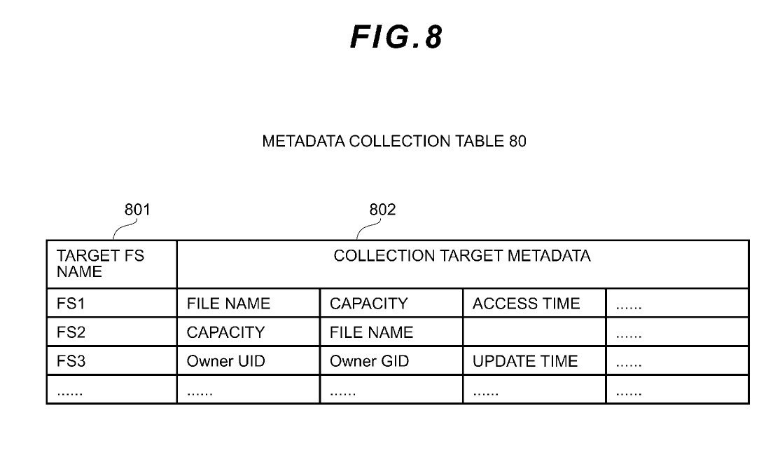

FIG. 8 is an example of the metadata collection table 80. The metadata collection table is constituted from an area 801 for setting a file system which is a target to collect the metadata, and an area 802 for setting the type of metadata which is a metadata target to be collected. This metadata collection table is set by the metadata collection unit 20443 based on the policy table 30A. The metadata collection unit 20443 sets the type of metadata to be obtained from the file to the metadata collection table 80 based on the statistic information type which is set to the policy table with respect to the file system which is the target to collect the statistic information. For example, if the statistic information type in the policy table is the extension, the metadata to be obtained from the file is a file name.

The aforementioned policy table 30A (FIG. 3) is set by the management program 1121 of the management computer 11 via the statistic information collection unit 30 for the file storage system 30 to the statistic information collection policy setting unit 30. The policy is set by the administrative user to the management program 1121 of the management computer 11 via the input/output unit 140.

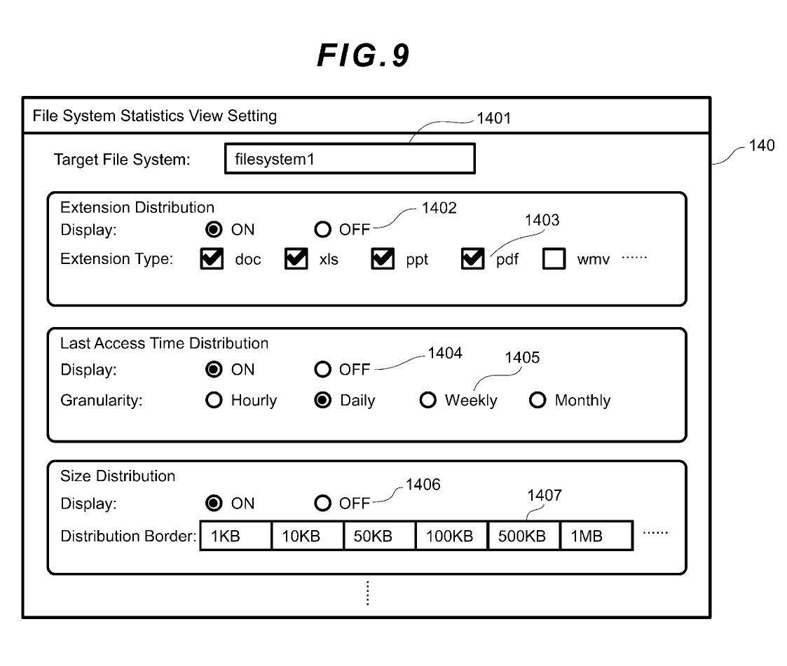

FIG. 9 is a policy setting GUI displayed on a screen of the input/output unit 140. The reference numeral 1401 in FIG. 9 indicates an area for inputting a file system which is a target to collect the statistic information and the reference numeral 1402 indicates an area for the administrative user to select whether the statistic information (file extension) should be displayed or not. The reference numeral 1403 indicates a check box for selecting the file extension as the statistic information. The reference numeral 1404 indicates an area for selecting whether the statistic information (last access time) should be displayed or not. The reference numeral 1405 indicates a check box for selecting the timing of the last access time. The reference numeral 1406 indicates an area for selecting whether the statistic information (file size) should be displayed or not. The reference numeral 1407 indicates an area for selecting a file size distribution border.

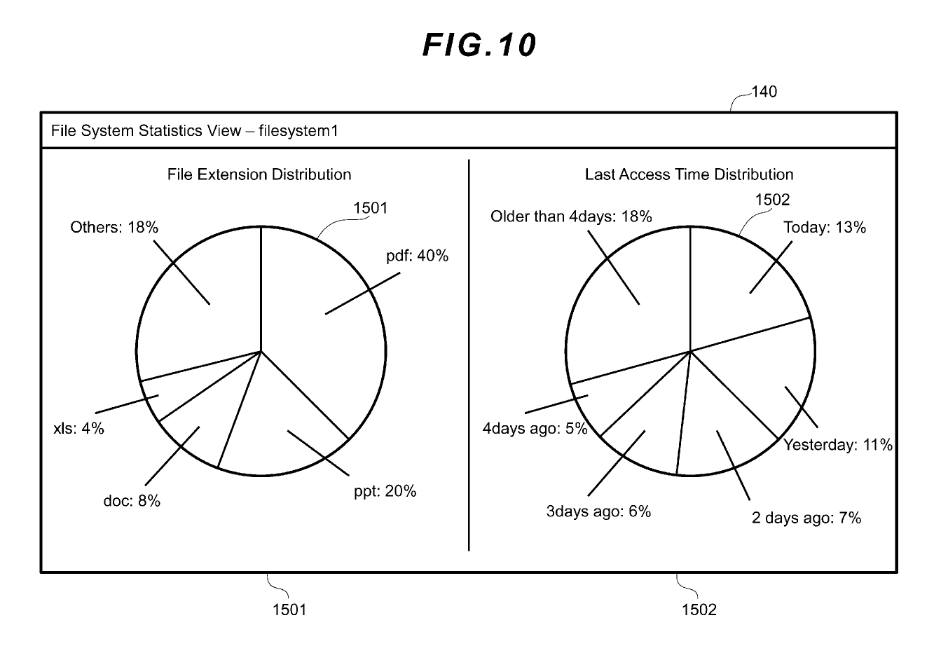

The statistic results are displayed as shown in FIG. 10, for example, in a form of a pie chart for each statistic result (classification by the file extension and classification by the last access time) as proportions of the number of files with respect to each of the plurality of pieces of statistic information to the total number of files in the relevant file system. The statistic information is displayed on the screen of the input/output unit 140 for the management computer 11 after receiving the results of the statistic information collection unit 2042 for the file storage system. The reference numeral 1501 indicates a statistic display example when the statistic information type is the file extension; and the reference numeral 1502 indicates a statistic display example when the statistic information type is the last access time to files.

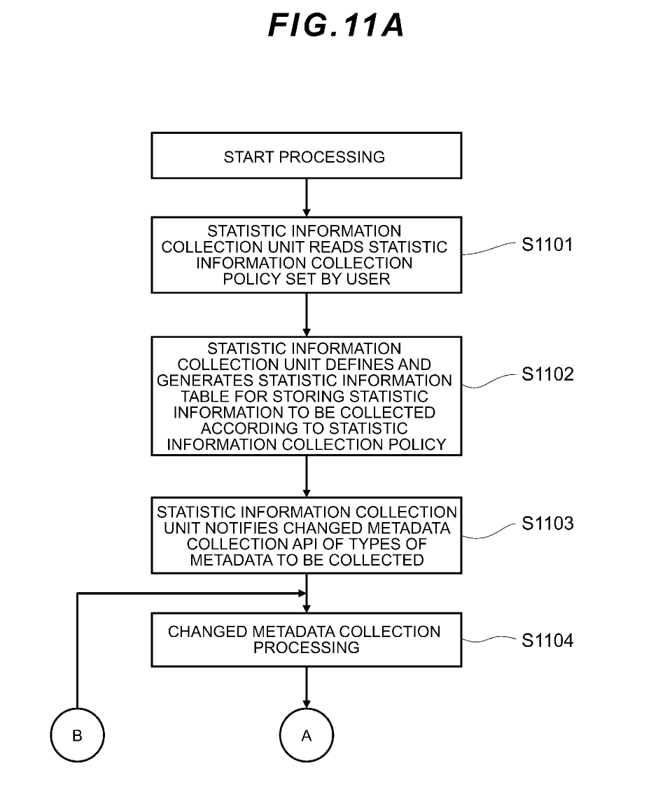

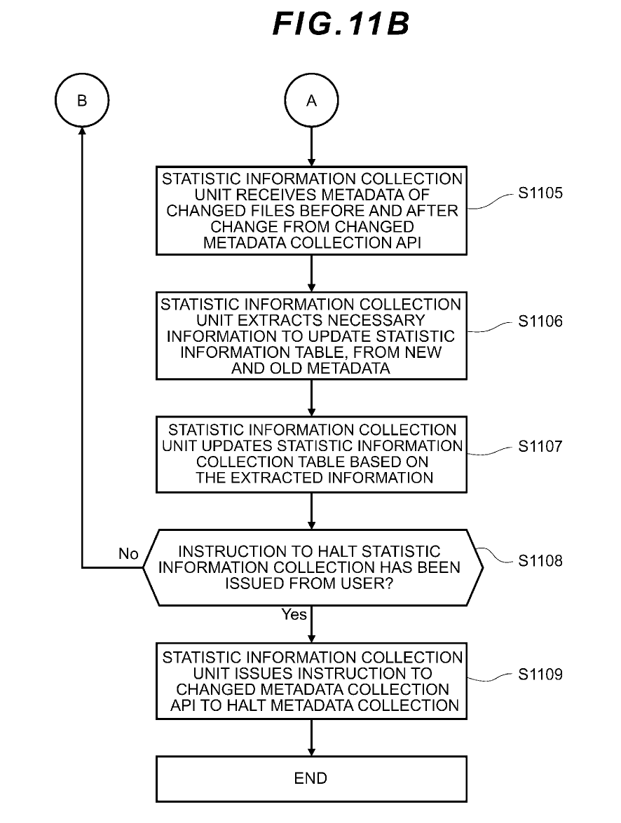

Next, the operation of the computer system according to the present invention will be explained. FIG. 11A and FIG. 11B are flowcharts illustrating the operation of the statistic information collection unit 2042. These flowcharts are actually executed by the CPU 203; however, the flowcharts will be explained by referring to the statistic information collection unit 2042, which is a subject of the function of the statistic information collection program, as an execution subject in order to make the explanation of the flowcharts easier to understand.

Firstly, as shown in FIG. 11A, the statistic information collection unit 2042 refers to the statistic information collection policy table 30A (FIG. 3) which is set by the user (S1101). Next, the statistic information collection unit 2042 either newly defines the statistic information table 40 for storing the statistic information to be collected or updates the definitions of the existing statistic information table, based on the statistic information collection policy which is set to the statistic information collection policy table 30A (S1102).

The statistic information collection unit 2042 notifies the changed metadata collection API (20441) of a file system(s) as a target(s) to collect the statistic information, which is set to the statistic information collection policy table 30A, as well as the type of the related metadata corresponding to a pattern of the statistic information to be collected from each file system (S1103). In step S1104, changed metadata collection processing by the changed metadata collection program is executed. The details of this processing will be explained below with reference to the other flowchart.

If any change of the related metadata happens with respect to a file belonging to the file system which is a statistic information collection target, the changed metadata collection API (20441) sends the related metadata before and after the change for the file, whose related metadata has been changed, to the statistic information collection unit 2042 as shown in FIG. 11B (S1105). If the file is newly created, the related metadata before the change becomes “Null.” If the file is deleted, the related metadata after the change becomes “Null.” Incidentally, the notification of the related metadata change is made every time the related metadata of a file is changed, for example, every time the file is update, created, or deleted; however, changes during a specified interval may be collectively reported.

The statistic information collection unit 2042 compares the related metadata before the change (old metadata) with the related metadata after the change (new metadata) and extracts necessary information to update the statistic information table (S1106). Then, the statistic information collection unit updates the statistic information table based on the extracted information (S1107). For example, if data is written to a certain file and its file size is changed (size before the change: 5 KB; and size after the change: 15 KB), the statistic information collection unit subtracts one from the number of file counts, which is 2340, for the file size (1 KB<file size<10 KB) belonging to the record [present] in the statistic information table (FIG. 6), subtracts 5 KB from the total capacity of 10.2 MB, adds one to the number of file counts, which is 3224, for the file size (10 KB<file size<50 KB), and adds 15 KB to the total capacity of 77.2 MB.

Furthermore, if the change of the related metadata is based on the creation of a new file, the statistic information collection unit 2042 adds one to the number of counts of files belonging to a record of that extension and adds the relevant file size to the total capacity based on the extension of the newly created file (see FIG. 4). On the other hand, if the change of the related metadata is based on a file deletion, the statistic information collection unit 2042 subtracts one from the number of counts of files belonging to a record of the deleted file and subtracts the relevant file size from the total capacity based on the extension of the deleted file.

Furthermore, if the related metadata is the last file access time, the statistic information collection unit 2042 refers to the last file access time before the change and updates the statistic information collection table 40. For example, referring to FIG. 5, when receiving a change of the related metadata in a case where the present date is Jul. 31, 2011, the statistic information collection unit 2042 adds one to [Number of Counts] in the area of [2011-07-31] at [Present] and adds the capacity of the file, whose metadata has been changed, to [Total Capacity]. Assuming that the previous access time for the relevant file was between [2011-07-30 00:00] and [2011-07-30 23:59], the statistic information collection unit 2042 subtracts one from [Number of Counts] for [2011-07-30] belonging to [present] and subtracts the file capacity from [Total Capacity].

In step S1108, the statistic information collection unit checks whether or not an instruction to halt the statistic information collection has been issued from the administrative user; and if an affirmative judgment is returned, the instruction to halt the metadata collection is issued to the changed metadata collection API (S1109). If a negative judgment is returned, the processing returns to step S1104 in FIG. 11A. The halt instruction is executed by the management computer 11 when, for example, maintaining the file systems or the file storage system or changing the statistic information collection policy. When the processing of the flowchart is halted and then later resumed, the statistic information collection unit 2042 starts from step S1101.

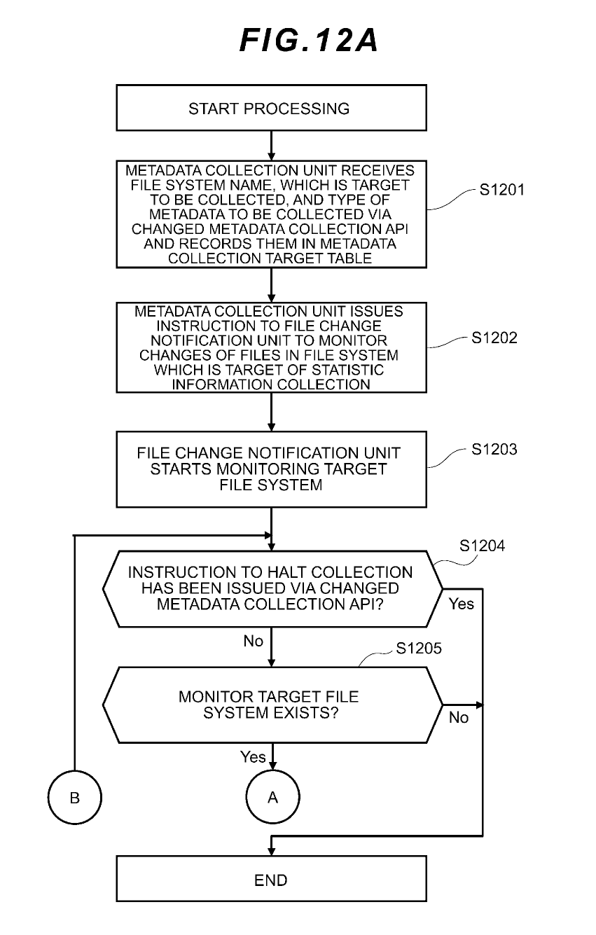

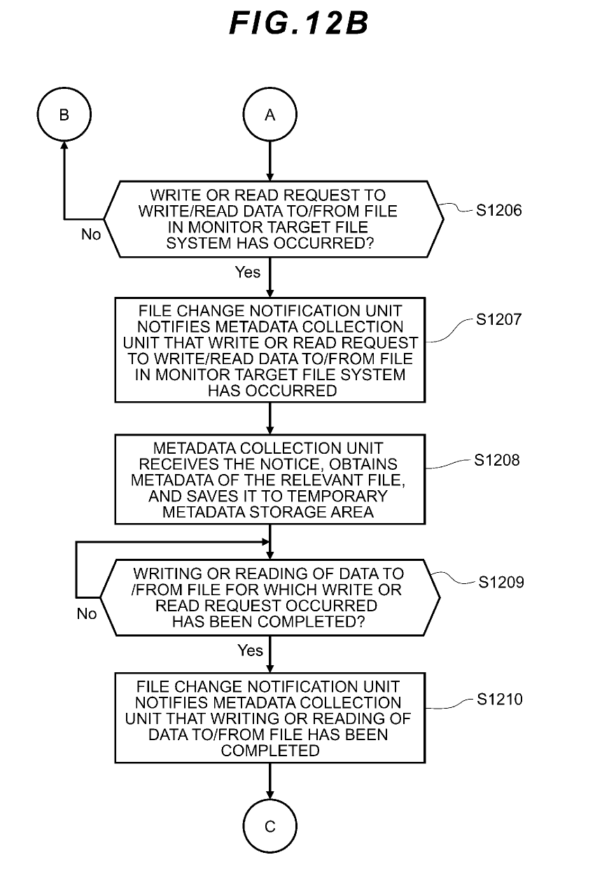

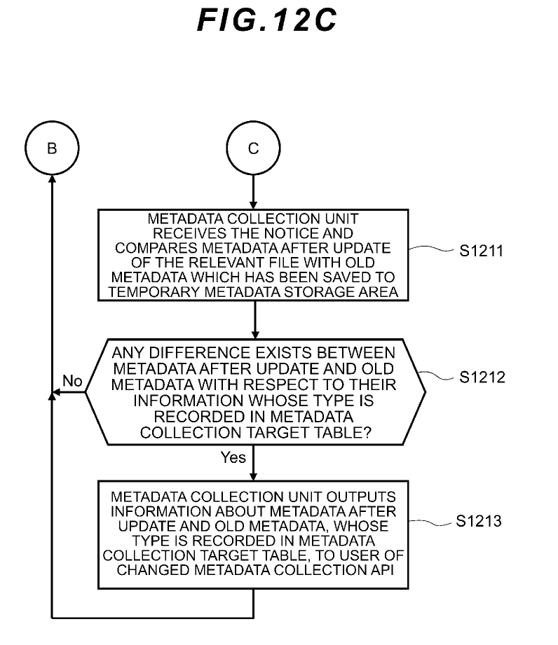

Next, processing for collecting the changed metadata will be explained. FIG. 12A to FIG. 12C are flowcharts for explaining the operation of the changed metadata collection processing program 2044 executing the metadata collection processing. Firstly, in S1201, the metadata collection unit 20443 receives information sent from the statistic information collection unit 2042 via the metadata collection API (20441), that is, a file system name, which is a statistic information collection target, and the type of the related metadata to be collected; and records them in the metadata collection target table 80.

The metadata collection unit 20443 refers to the metadata collection target table 80 and sets the file change notification unit 20445 so that the statistic information collection target file system will be a monitor target (S1202). Next, the file change notification unit 20445 starts monitoring the statistic information collection target file system (S1203). This monitoring is to check whether or not access from the client computer 12 is made to a file belonging to the monitor target file system.

Then, the metadata collection unit 20443 checks, via the changed metadata collection API (20441), whether an instruction to halt the collection has been issued or not (S1204, S1109). If the halt instruction has been issued, the metadata collection unit 20443 terminates the processing of the flowchart. If the halt instruction has not been issued, the file change notification unit 20445 checks the file system storage information area of the memory and checks whether or not the monitor target file system exists in the file storage system, in step S1205. If the file system does not exist, the file change notification unit 20445 terminates the processing of the flowchart.

If a negative judgment is returned in step S1204 and an affirmative judgment is returned in step S1205, the processing of the flowchart proceeds to step S1206 (FIG. 12B); and the file change notification unit 20445 always analyzes accesses from the client computer 12 and judges whether a file which is a file access request target belongs to the monitor target file system and whether an access command causes a change in the metadata, for example, whether or not a write command has occurred when the file size is a collection target. Furthermore, if the last access time is the collection target, the file change notification unit 20445 judges whether or not a read command has occurred.

If the file change notification unit 20445 returns an affirmative judgment in this step, the file change notification unit 20445 issues a command to the OS to have the file system temporarily stop writing/reading data to/from the file and notifies the metadata collection unit 20443 that the write/read request to write/read data to/from the file in the monitor target file system has occurred (S1207). If the file change notification unit 20445 returns a negative judgment in step S1206, the processing returns to S1204

After receiving the notification from the file change notification unit 20445, the metadata collection unit 20443 refers to the metadata collection target table 80 and identifies the type of the collection target metadata that is set for the file system to which the write/read request target file belongs. Then, the metadata collection unit 20443 reads the identified type of the related metadata from the file and saves and records it to a temporary storage area of the temporary metadata storage unit 20444 (S1208). Furthermore, the metadata collection unit 20443 issues a command to the OS to cancel the file writing/reading halt. The related metadata recorded in the temporary metadata storage area is metadata before data was written to or read from the file according to the write/read command.

The file change notification unit 20445 judges whether writing/reading of data to/from the file for which the write/read request was made has been completed or not (S1209). If writing/reading of data to/from the file has been completed, the file change notification unit 20445 notifies the metadata collection unit 20443 that writing/reading of data to/from the file has been completed (S1210). The file change notification unit 20445 monitors a write/read completion response from the OS, which controls commands from the client computer, to the client computer 12.

After receiving the notification, the metadata collection unit 20443 reads updated metadata from the file, to or from which data was written or read, reads old metadata, which has been saved to the temporary metadata storage area, and then compares the updated metadata with the old metadata (S1211: FIG. 12C).

Subsequently, the metadata collection unit 20443 refers to the metadata collection target table 80 and judges whether any difference exists between the updated metadata and the pre-update metadata with respect to the metadata of the type defined as the metadata collection target (S1212). If any difference exists, the metadata collection unit 20443 outputs the updated metadata and the old metadata via the metadata collection API (20441) to the statistic information collection unit 2042 (S1213). If a negative judgment is returned in this step, the processing returns to S1204.

If the file system is accessed and the statistic information about the file system changes before and after the access, the computer system always monitors the changes of the file system and updates the statistic results of the file system according to the changes as the result of the above-described processing. Therefore, it is possible to always maintain the statistics of the file system in the latest state. When this is performed, the load imposed by the updates on the computer system is not so large.

In the aforementioned embodiment, the changed metadata collection program and the statistic information processing program are located in the file storage system, but they may be located in the management computer. Furthermore, the statistic information table 40 is used to record the statistic results relating to one type of metadata, but it may be used to record the statistic results relating to a plurality of types of metadata, for example, in a case where distribution of last file access time is recorded with respect to one extension.

Furthermore, in the aforementioned embodiment, the difference in the metadata before and after the file access is checked by the changed metadata collection program; however, this check may be performed by the statistic information collection unit. Furthermore, the statistic information table is updated when a file is accessed; however, this update may be performed at certain time intervals, for example, every several hours.

### REFERENCE SIGNS LIST

11 Management computer

12 Client computer

20 File storage system

70 File

203 Arithmetic unit (controller)

205 Disk array system

2044 Changed metadata collection program

2045 File system

1. A computer system comprising:
a memory having a program for collecting metadata of files in a file system and statistic information of the file system; and
a controller for executing the program;
wherein, upon receiving an access request of a file in the file system, the controller reads first metadata of the file before executing the access request, saves the first metadata, and then executes the access request, reads second metadata of the file after executing of the access request, compares the first metadata and second metadata; and if it is determined that any difference exists between the first metadata and the second metadata, the controller updates a statistic information of the file system based on the difference.

2. The computer system according to claim 1, wherein the computer system has a file storage system and a management computer and the file system includes the memory and the controller.

3. The computer system according to claim 1, wherein the controller monitors access to the file system; and if the access is detected, the controller obtains the first metadata and the second metadata from the file system.

4. The computer system according to claim 1, wherein the memory has a policy table with respect to statistic information to be collected from the file system; and
the controller collects the first metadata and the second metadata from the file system in accordance with the policy table.

5. The computer system according to claim 4, wherein a policy about the statistic information is recorded in the policy table and the policy is defined by including the file system from which the statistic information should be collected, and a type of the statistic information to be collected from the file system.

6. The computer system according to claim 1, wherein the memory includes a statistic information table in which a statistic result based on the first metadata is recorded; and
wherein the controller executes:
first processing for collecting the first metadata and the second metadata from the file system; and
second processing for determining an update part of the statistic information table according to the first metadata and the second metadata and updates the statistic information table based on the difference.

7. The computer system according to claim 1, wherein the memory has a first program for collecting the metadata from the file in the file system and a second program for executing statistics on the collected metadata; and
wherein the second program:
reads a statistic information collection policy;
sets an information table for storing a statistic result of the collected metadata by classifying the statistic result for each specified date and time, based on the policy;
determines a type of the metadata to be collected based on the policy and notifies the first program of the determined type of the metadata and the file system from which the metadata should be collected;
receives the metadata before and after access to the file in that file system from the first program; and
obtains update information for the information table from the received metadata and updates the information table based on the update information.

8. The computer system according to claim 7, wherein the first program:
monitors whether or not a write request or read request, to write data to, or read data from, the file in the file system reported by the second program has occurred;
judges whether or not the request will cause a change in the metadata of the file if the request has occurred;
temporarily stops processing of the request if an affirmative judgment is returned in the above judgment;
collects the metadata from the file before processing the request and stores the collected metadata in a temporary storage area;
collects the metadata from the file after processing the request;
reads the metadata collected before processing the request from the temporary storage area and compares the metadata before processing the request with the metadata after processing the request; and
outputs both pieces of the metadata to the second program if there is any difference between the metadata before processing the request and the metadata after processing the request.

9. A file system management method using a computer system comprising:
whenever an access request of a file in the file system is received,
reading first metadata of the file before executing the access request;
saving the first metadata; and then
executing the access request;
reading second metadata of the file after executing of the access request;
comparing the first metadata and second metadata; and
if it is determined that any difference exists between the first metadata and the second metadata, updating the statistic information of the file system based on the difference.
